(19) United States
(12) Patent Application Publication
(10) Pub. No.: US 2026/0300051 A1
(43) Pub. Date: Oct. 1, 2026

(54) DEVICE INTERACTION METHOD AND SYSTEM, DEVICE AND READABLE STORAGE MEDIUM

(71) Applicants: Beijing BOE Technology Development Co., Ltd., Beijing (CN); BOE TECHNOLOGY GROUP CO., LTD., Beijing (CN)

(72) Inventor: Dongbo CAO, Beijing (CN)

(21) Appl. No.: 19/479,438

(22) PCT Filed: Mar. 14, 2024
(86) PCT No.: PCT/CN2024/081555

§ 371 Date: Oct. 28, 2025

(30) Foreign Application Priority Data
Apr. 28, 2023 (CN) 202310478257.7

(51) Int. Cl. G06F 9/54; G06F 13/42

(52) U.S. Cl. CPC G06F 9/544; G06F 13/4282

(57) ABSTRACT

A device interaction method, a device interaction system, a device and a readable storage medium are provided. The device interaction system includes a first device and a second device, and the first device is communicatively coupled to the second device; the first device is configured to receive an instruction or an operation of a user, generate a calling request for a target service, detect whether the target service is a service of the second device, and in a case that the target service is the service of the second device, send the calling request to the second device; and the second device is configured to receive the calling request, and return memory data of the target service to the first device.

### CROSS-REFERENCE TO RELATED APPLICATION

This application is the U.S. national phase of PCT Application No. PCT/CN2024/081555 filed on Mar. 14, 2024, which claims a priority of the Chinese patent application No. 202310478257.7 filed on Apr. 28, 2023, which is incorporated herein by reference in its entirety.

### TECHNICAL FIELD

The present disclosure relates to the field of computer technology, in particular to a device interaction method, a device interaction system, a device and a readable storage medium.

### BACKGROUND

As a pluggable device, an Open Pluggable Specification (OPS) device may be mounted on a display device and provide an OPS system for the display device, so that the display device displays content provided by the OPS system.

In the related art, usually an all-in-one machine is used in combination with the OPS device, but the all-in-one machine has an operating system independent of the OPS device, and in a case that the all-in-one machine needs to call a service of the OPS device, it is necessary to copy a service-related file of the OPS device to the all-in-one machine and then open the file. Hence, the operation is complicated and causes inconvenience to a user.

### SUMMARY

An object of the present disclosure is to provide a device interaction method, a device interaction system, a device and a readable storage medium, so as to solve the problem that a service calling operation between devices is inconvenient.

In order to solve the above-mentioned problem, the present disclosure provides the following technical solutions.

In one aspect, the present disclosure provides in some embodiments a device interaction system, including a first device and a second device. The first device is communicatively coupled to the second device; the first device is configured to receive an instruction or an operation of a user, generate a calling request for a target service, detect whether the target service is a service of the second device, and in a case that the target service is the service of the second device, send the calling request to the second device; and the second device is configured to receive the calling request, and return memory data of the target service to the first device.

In some embodiments of the present disclosure, the first device is further configured to, upon the receipt of the memory data of the target service returned by the second device, display the memory data of the target service on a display interface of the first device.

In some embodiments of the present disclosure, the first device is coupled to the second device via a Universal Serial Bus (USB).

In some embodiments of the present disclosure, the calling request for the target service includes a descriptor corresponding to the target service; and the first device is specifically configured to detect whether the target service is the service of the second device according to the descriptor corresponding to the target service and information about each service of the second device recorded in a service list of the first device.

In some embodiments of the present disclosure, the second device is further configured to send information about each service of the second device to the first device; and the first device is further configured to receive the information about each service of the second device, and record the information about each service of the second device in the service list of the first device.

In some embodiments of the present disclosure, the first device is configured with a service manager, and the service manager is configured to receive the information about each service of the second device and record the information about each service of the second device in the service list of the first device.

In some embodiments of the present disclosure, the first device includes a reserved first physical memory, and the first physical memory is divided into a plurality of physical pages; and the second device includes a reserved second physical memory, the second physical memory is divided into a plurality of physical pages, and page indices of the plurality of physical pages of the first device are different from page indices of the plurality of physical pages of the second device.

In some embodiments of the present disclosure, the page indices of the plurality of physical pages of the first device and the page indices of the plurality of physical pages of the second device are continuous.

In some embodiments of the present disclosure, the first device is specifically configured to receive a first data packet returned by the second device, and the first data packet includes a protocol head, a length of the memory data, an address of a physical memory occupied by the memory data, and the memory data.

In some embodiments of the present disclosure, the first data packet further includes an index of the physical page storing the memory data.

In some embodiments of the present disclosure, the first device includes a client process, and the client process is an application process.

In some embodiments of the present disclosure, the first device includes a client process and a first Binder driver, and the second device includes a second Binder driver and a service process; the first Binder driver is configured to receive the calling request sent by the client process, determine information about the target service from the service list according to the descriptor in the calling request, determine whether the target service is a service of the first device or the service of the second device according to the information about the target service, and in a case that the target service is the service of the second device, send the calling request to the second Binder driver; the second Binder driver is configured to receive the calling request, and send the calling request to the service process corresponding to the target service; the service process is configured to parse the calling request, and send the memory data of the target service to the second Binder driver; the second Binder driver is further configured to send the memory data of the target service to the first Binder driver; and the first Binder driver is further configured to send the memory data of the target service to the client process.

In some embodiments of the present disclosure, the first device is an all-in-one machine, and the second device is an OPS device; or the second device is an all-in-one machine, and the first device is an OPS device.

In another aspect, the present disclosure provides in some embodiments a device interaction method, applied to a device interaction system. The device interaction system includes a first device and a second device, and the first device is communicatively coupled to the second device. The device interaction method includes: receiving, by the first device, an instruction or an operation of a user, generating a calling request for a target service, detecting whether the target service is a service of the second device, and in a case that the target service is the service of the second device, sending the calling request to the second device; and receiving, by the second device, the calling request, and returning memory data of the target service to the first device.

In some embodiments of the present disclosure, the device interaction method further includes: upon the receipt of the memory data of the target service returned by the second device, displaying, by the first device, the memory data of the target service on a display interface of the first device.

In some embodiments of the present disclosure, the first device is coupled to the second device via a USB.

In some embodiments of the present disclosure, the calling request for the target service includes a descriptor corresponding to the target service; and the detecting whether the target service is the service of the second device includes: detecting, by the first device, whether the target service is the service of the second device according to the descriptor corresponding to the target service and information about each service of the second device recorded in a service list of the first device.

In some embodiments of the present disclosure, the device interaction method further includes: sending, by the second device, the information about each service of the second device to the first device; and receiving, by the first device, the information about each service of the second device, and recording the information about each service of the second device in the service list of the first device.

In some embodiments of the present disclosure, the first device includes a reserved first physical memory, and the first physical memory is divided into a plurality of physical pages; and the second device includes a reserved second physical memory, the second physical memory is divided into a plurality of physical pages, and page indices of the plurality of physical pages of the first device are different from page indices of the plurality of physical pages of the second device.

In some embodiments of the present disclosure, the page indices of the plurality of physical pages of the first device and the page indices of the plurality of physical pages of the second device are continuous.

In some embodiments of the present disclosure, the returning the memory data of the target service to the first device includes: returning, by the second device, a first data packet to the first device, and the first data packet includes a protocol head, a length of the memory data, an address of a physical memory occupied by the memory data, and the memory data.

In some embodiments of the present disclosure, the first data packet further includes an index of the physical page storing the memory data.

In some embodiments of the present disclosure, the first device includes a client process and a first Binder driver, and the second device includes a second Binder driver and a service process. The device interaction method specifically includes: receiving, by the first Binder driver, the calling request sent by the client process, determining information about the target service from the service list according to the descriptor in the calling request, determining whether the target service is a service of the first device or the service of the second device according to the information about the target service, and in a case that the target service is the service of the second device, sending the calling request to the second Binder driver; receiving, by the second Binder driver, the calling request, and sending the calling request to the service process corresponding to the target service; parsing, by the service process, the calling request, and sending the memory data of the target service to the second Binder driver; sending, by the second Binder driver, the memory data of the target service to the first Binder driver; and sending, by the first Binder driver, the memory data of the target service to the client process.

In yet another aspect, the present disclosure provides in some embodiments a device, including a device and a memory. The memory is configured to store therein a program or instruction executed by the processor, and the program or instruction is used to be executed by the processor to implement the steps of the above-mentioned device interaction method.

In still yet another aspect, the present disclosure provides in some embodiments a readable storage medium storing therein a program or instruction, and the program or instruction is used to be executed by a processor to implement the steps of the above-mentioned device interaction method.

In the embodiments of the present disclosure, upon the receipt of the calling request for the target service of the second device, the first device sends the calling request to the second device, and receives the memory data of the target service returned by the second device. The first device shares the memory data of the target service, so the first device may directly call the target service. Through the technical solution in the embodiments of the present disclosure, it is able to call the service between the first device and the second device, thereby to facilitate the user to call the service of the second device through the first device.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a block diagram of a device interaction system according to an embodiment of the present disclosure;

FIG. 2 is a schematic view showing architecture of Android Binder in the related art;

FIG. 3 is a schematic view showing architecture of Android Binder according to an embodiment of the present disclosure;

FIG. 4 is a schematic view showing the management of memory data according to an embodiment of the present disclosure;

FIG. 5 is a schematic view showing a calling process of a Binder driver in the related art;

FIG. 6 is a schematic view showing a calling process of a Binder driver according to an embodiment of the present disclosure;

FIG. 7 is a flow chart of a device interaction method according to an embodiment of the present disclosure; and

FIG. 8 is a schematic view showing a device according to an embodiment of the present disclosure.

### DETAILED DESCRIPTION

The technical solutions of the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

In the embodiments of the present disclosure, such terms as “include” or “including” or any other variations involved in the present disclosure intend to provide non-exclusive coverage, so that a procedure, method, system, product or device including a series of steps or units may also include any other elements not listed herein, or may include any inherent steps or units of the procedure, method, system, product or device. In addition, the expression “and/or” is merely used to represent at least one of the objects before and after the expression. For example, “A and/or B and/or C” represents seven situations, i.e., there is only A, there is only B, there is only C, there are both A and B, there are both B and C, there are both A and C, and there are A, B and C.

An object of the present disclosure is to provide a device interaction method, a device interaction system, a device and a readable storage medium, so as to solve the problem that a service calling operation between devices is inconvenient.

A device interaction scheme in the embodiments of the present disclosure may be applied to an electronic device, e.g., an intelligent all-in-one machine or an electronic computer.

In the embodiments of the present disclosure, merely the intelligent all-in-one machine is taken as an example. The intelligent all-in-one machine is also called as all-in-one machine, intelligent tablet, or conference tablet, and it is an intelligent device which supports a human-machine interaction function, e.g., touching. Usually, the intelligent all-in-one machine supports a plurality of operating signal sources, e.g., it may run an operating system mounted thereon, or run on the basis of a signal from an external device. These electronic devices merely support a single system at a same time, e.g., Android system or Windows system. In order to improve the adaptability to different scenarios, the intelligent all-in-one machine is provided with multi-system support. For example, the intelligent all-in-one machine operates on the basis of a highly-tailored Android system to improve the user experience, and in some scenarios, it also supports the Windows system to provide a better software service. In the related art, the all-in-one machine supports the Windows system through an OPS (a computational module plugin format) device.

The present disclosure provides in some embodiments a device interaction system which, as shown in FIG. 1, includes a first device 11 and a second device 12. The first device 11 is communicatively coupled to the second device 12; the first device 11 is configured to receive an instruction or an operation of a user, generate a calling request for a target service, detect whether the target service is a service of the second device 12, and in a case that the target service is the service of the second device 12, send the calling request to the second device 12; and the second device 12 is configured to receive the calling request, and return memory data of the target service to the first device 11.

In the embodiments of the present disclosure, upon the receipt of the calling request for the target service of the second device, the first device sends the calling request to the second device, and receives the memory data of the target service returned by the second device. The first device shares the memory data of the target service, so the first device may directly call the target service. Through the technical solution in the embodiments of the present disclosure, it is able to call the service between the first device and the second device, thereby to facilitate the user to call the service of the second device through the first device.

In some embodiments of the present disclosure, the first device is installed with a first operating system, the second device is installed with a second operating system, and the first operating system is identical to, or different from, the second operating system. The first operating system is an Android system and the second operating system is a Windows system, or the first operating system is an Android system and the second operating system is an Android system. Obviously, the first device, the second device and the operating systems are not limited thereto.

The first device is communicatively coupled to the second device via a wireless local area network, or a data interface such as wireless hotspot, cable or USB interface, which will not be particularly defined herein.

The first device is an all-in-one machine, and the second device is an OPS device; or the second device is an all-in-one machine, and the first device is an OPS device. The words “first” and “second” are merely used to differentiate the devices from each other, and for each device, it is the first device, and an opposite device is the second device.

In some embodiments of the present disclosure, the first device is further configured to, upon the receipt of the memory data of the target service returned by the second device, display the memory data of the target service on a display interface of the first device. In this way, a user may directly operate the target service using the display interface of the first device. To be specific, the target service is a camera service. The camera service is provided by the second device rather than the first device. Upon the receipt of the calling request for the camera service, the first device detects that the camera service is the service of the second device, sends the calling request to the second device, and receives memory data of the camera service returned by the second device. The first device displays the memory data of the camera service on the display interface, and the user directly uses the camera service using the display interface of the first device. In this way, the first device may utilize resources of the second device, so as to increase the utilization of the service resources, and facilitate the user to call the service of the second device through the first device.

In some embodiments of the present disclosure, the second device is further configured to send information about each service of the second device to the first device; and the first device is further configured to receive the information about each service of the second device, and record the information about each service of the second device in the service list of the first device.

In the embodiments of the present disclosure, the first device not only manages information about each service of the first device itself, but also manages the information about each service of the second device. The information about the service includes, but not limited to, a size and a name of the service, memory occupied by the service, and the device to which the service belongs. The information about each service of the first device and the information about each service of the second device are recorded in the service list of the first device. In this way, through the service list, the first device determines the target service is the service of the first device or the service of the second device. Identically, the second device not only manages information about each service of the second device itself, but also manages the information about each service of the first device. The second device is also provided with a service list for recording the information about each service of the first device and the information about each service of the second device.

In some embodiments of the present disclosure, the first device is configured with a service manager, and the service manager is configured to receive the information about each service of the second device and record the information about each service of the second device in the service list of the first device. The first device includes a client process, and the client process is an application process, so as to receive the instruction or operation of the user, and generate the calling request.

In some embodiments of the present disclosure, the calling request for the target service includes a descriptor corresponding to the target service, and the descriptor corresponding to the target service is used to describe the information about the service, including a size and a name of the service, memory occupied by the service, etc. The first device is specifically configured to detect whether the target service is the service of the second device according to the descriptor corresponding to the target service and information about each service of the second device recorded in a service list of the first device.

The first device searches for a service record according to the descriptor corresponding to the target service, determines the information about the target service corresponding to the descriptor, and determines whether the target service is the service of the second device or the service of the first device according to the information about the target service. In a case that the target service is the service of the first device, the first device directly calls the target service; and in a case that the target service is the service of the second device, it sends the calling request to the second device.

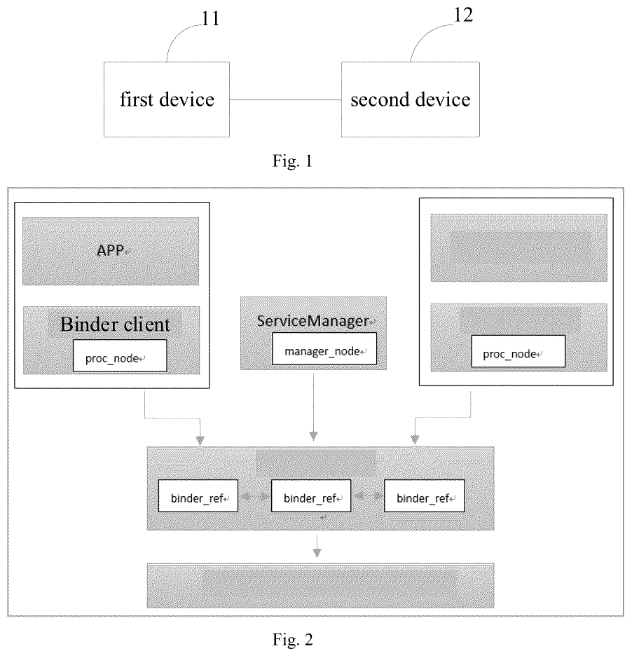

The technical solution in the embodiments of the present disclosure is implemented via Android Binder architecture. FIG. 2 shows the Android Binder architecture in the related art, and an application (APP) interacts with a corresponding service. A service manager takes charge of managing all services, and Android services are registered into the service manager through a service process. During the registration, the Android service obtains a proxy object of the service manager, and then it is registered into the service manager via the proxy object. A reference count and an object reference of a service object are packaged and transferred to a kernel, and the reference count and the object reference of the service object are reserved in a global linked list Binder_context_mgr_node in a Binder driver in the form of Binder_node, i.e., it may be considered that there is a service list in the service manager for recording the information about the service.

In a case that the APP requests for a corresponding service through the client process, a reference object Binder_ref is created in the kernel, and it includes a descriptor desc for describing the information about the service, including a size and a name of the service, memory occupied by the service, etc. The reference object Binder_ref is suspended under a current process Binder_proc. The reference object Binder_ref is returned to a user space, and a corresponding proxy object is generated according to the descriptor desc. In a case that a client uses the service function via the proxy object, it sends the descriptor desc to a Binder kernel driver, so as to find the corresponding reference object Binder_ref and then find a corresponding service user space object, thereby to use a corresponding service.

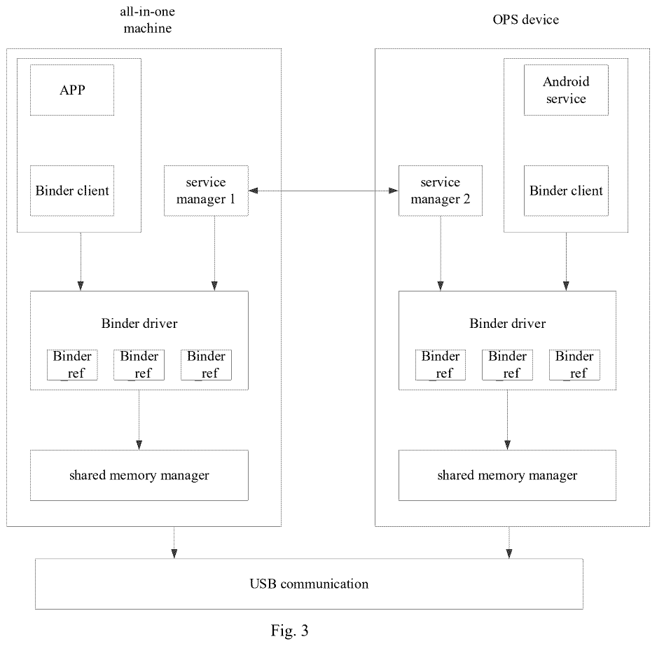

In a case that the first device is the all-in-one machine and the second device is the OPS device, in the embodiments of the present disclosure, the Android Binder architecture is extended. As shown in FIG. 3, the service managers are arranged at a first device side and a second device side respectively, and each service manager records not only the information about the service of the corresponding device but also the information about the service of the opposite device. In a case that there are services with a same name, the services need to be numbered. For example, the first device and the second device are provided with a service FileManager, the service FileManager of the first device is numbered as FileManager1, and the service FileManager of the second device is numbered as FileManager2.

In other words, for the Binder driver, both the information about the service of the corresponding device and the information about the service of the opposite device are recorded in the object linked list Binder_ref (i.e., the above-mentioned service list). The first device is communicatively coupled to the second device via the USB, and the first device obtains the information about the service of the second device via the USB. To be specific, after the device is started, the service of the first device itself is registered into the service manager, the first device obtains the service of the second device via the USB, and the service of the second device is also registered into the service manager. In a case that the APP of the all-in-one machine requests for a corresponding service through the client process, a reference object Binder_ref (including the descriptor desc) is created in the kernel, and Binder_ref is notified to a Binder driver in the kernel of the OPS device. In this way, in a case that a certain service of the OPS device is called by the all-in-one machine through the client process, the Binder driver of the OPS device may correctly perform the processing.

In a case that a function of the target service is used by the client process through the proxy object, the descriptor desc corresponding to the target service is transferred to the Binder driver. The Binder driver searches for a corresponding Binder_node. In a case that the Binder driver fails to find the corresponding Binder_node at the first device, it may search for it at the second device. After the Binder driver has found a corresponding service user space object, a corresponding service may be used.

In some embodiments of the present disclosure, the first device includes a reserved first physical memory, and the first physical memory is divided into a plurality of physical pages; and the second device includes a reserved second physical memory, the second physical memory is divided into a plurality of physical pages, and page indices of the plurality of physical pages of the first device are different from page indices of the plurality of physical pages of the second device. Part of physical memory is reserved by the first device as the first physical memory shared with the second device, and part of physical memory is reserved by the second device as the second physical memory shared with the first device. Each physical page has a fixed size, e.g., 4K bits, the physical page is used to store the memory data of the service, and the memory data of the service occupies one or more physical pages. The physical memory of the device is managed using the physical pages, so as to prevent a waste of memory resources. In order to facilitate the calling of the memory data between the devices, the physical pages of the first device and the physical pages of the second device are assigned with different page indices, and in a case of searching for the physical page, each page index uniquely represents one physical page.

In some embodiments of the present disclosure, the page indices of the plurality of physical pages of the first device and the page indices of the plurality of physical pages of the second device are continuous. For example, the page indices of the physical pages of the first device include 0 to 1023, and the page indices of the physical pages of the second device include 1024 to 2047. Of course, the page indices of the plurality of physical pages of the first device and the page indices of the plurality of physical pages of the second device are not limited to be continuous, as long as the page indices of the plurality of physical pages of the first device are different from the page indices of the plurality of physical pages of the second device.

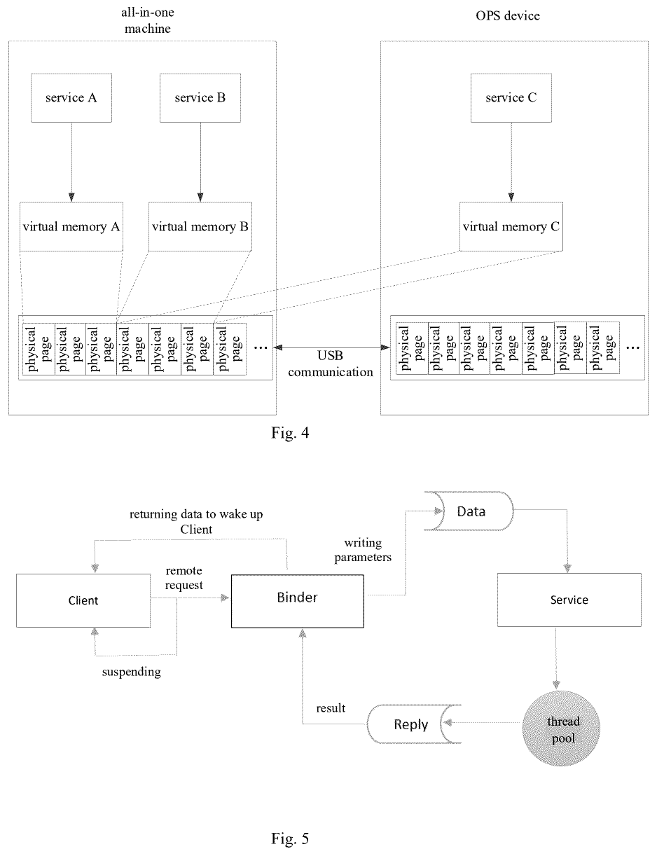

To be specific, in a case that the operating systems of the first device and the second device are started, part of the physical memory of the first device and the second device is reserved, i.e., the first physical memory is reserved by the first device, and the second physical memory is reserved by the second device. Then, the page indices are created for the two parts of physical memory to share the memory at a bottom layer in a cross-device manner. At an upper layer of the Android system, an accessed memory may be considered to be located inside the corresponding device. As shown in FIG. 4, the all-in-one machine includes a service A and a service B, memory data of the service A is stored through first three physical pages of the first device, and memory data of the service B is stored through fourth to seventh physical pages of the first device. The OPS device calls the memory data of the service B of the all-in-one machine through a virtual memory C, so as to call the service B. To be specific, in a case that the memory data of the service B of the all-in-one machine is called through the virtual memory C, the all-in-one machine sends the memory data of the service B to the OPS device via the USB. Upon the receipt of the memory data of the service B, the OPS device stores the memory data of the service B in the physical page or a cache, and it may use the memory data of the service B subsequently.

In some embodiments of the present disclosure, the first device is specifically configured to receive a first data packet returned by the second device, and the first data packet includes a protocol head, a length of the memory data, an address of a physical memory occupied by the memory data, and the memory data. In the embodiments of the present disclosure, the first data packet is used to transmit the memory data.

In some embodiments of the present disclosure, the first data packet further includes an index of the physical page storing the memory data. In this way, at the first device end, it is able to manage the physical mage storing the memory data.

In the embodiments of the present disclosure, the shared memory between the devices is executed via a USB communication protocol. Content delivered between the devices includes information indicating that a specific physical page is indexed, and data in the shared memory. The first data packet includes: HEAD, which indicates a protocol type of the first data packet; Length, which indicates a size of the entire first data packet (in a case that the to-be-transmitted memory data is large, it is divided into a plurality of first data packets, i.e., a size of the memory data transmitted in one shot is controlled to be smaller than or equal to a size of the physical page, i.e., 4K bits); Page index, which represents a serial number of a to-be-shared physical page, i.e., an index of the physical page; Phy addr, which represents an address of a to-be-shared physical memory; Len, which represents a specific length of the to-be-transmitted memory data; Opt, which represents an extensible item (an optional item); and Data, which represents the memory data.

Through the first data packet, it is able to transmit the memory data between the devices.

The indices of the physical pages are page indices uniformly created for the physical memory reserved by the first device and the second device in a case that the operating systems of the first device and the second device are started, and the addresses of the to-be-shared physical memory include an address of the first physical memory reserved by the first device and an address of the second physical memory reserved by the second device.

In the embodiments of the present disclosure, the service is called more conveniently between the devices based on a Binder mechanism. In some embodiments of the present disclosure, the first device includes a client process and a first Binder driver, and the second device includes a second Binder driver and a service process; the first Binder driver is configured to receive the calling request sent by the client process, determine information about the target service from the service list according to the descriptor in the calling request, determine whether the target service is a service of the first device or the service of the second device according to the information about the target service, and in a case that the target service is the service of the second device, send the calling request to the second Binder driver; the second Binder driver is configured to receive the calling request, and send the calling request to the service process corresponding to the target service; the service process is configured to parse the calling request, and send the memory data of the target service to the second Binder driver; the second Binder driver is further configured to send the memory data of the target service to the first Binder driver; and the first Binder driver is further configured to send the memory data of the target service to the client process.

In the related art, in order to call a service within a device, FIG. 5 shows a Binder calling process for the Android system.
1) After the service process is started, it enters an interruptible waiting state, so as to wait for a request from the client process.
2) In a case that the client process needs to communicate with the service process, it sends a scheduling request to the Binder driver.
3) Upon the receipt of the scheduling request, the Binder driver wakes up the service process. The Binder driver also sends a response message to the client process, so as to notify the client process that the Binder driver has received the scheduling request.
5) After sending the scheduling request successfully, the client process enters a waiting state, so as to wait for a response from the service process.
6) After the Binder driver wakes up the service process, it forwards the scheduling request to the service process.
7) The service process parses content in the scheduling request, and sends a response (including the memory data of the called service) to the Binder driver.
8) Upon the receipt of the response, the Binder driver wakes up the client process, the client process receives a processing result returned by the service process, and the entire calling process is ended.

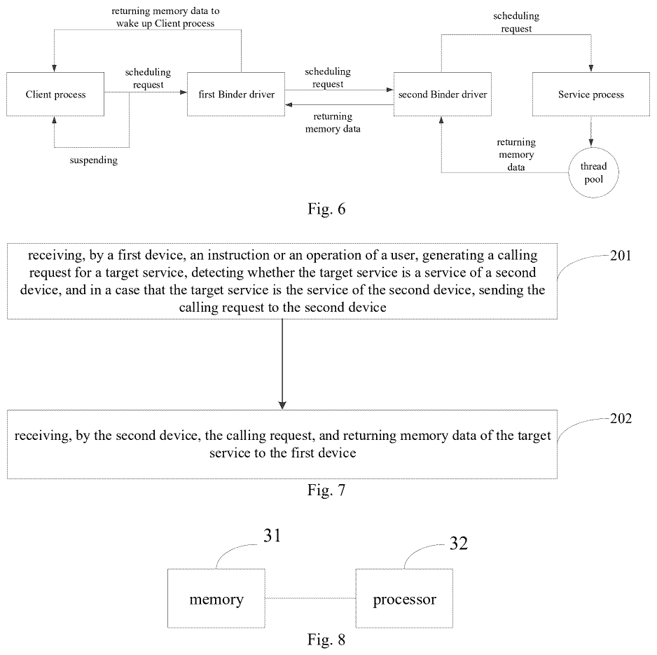

In the embodiments of the present disclosure, in order to call the service between the devices, FIG. 6 shows a Binder calling process for the Android system.
1) After the service process is started, it enters an interruptible waiting state, so as to wait for a request from the client process.
2) In a case that the client process needs to communicate with the service process, it sends the scheduling request to the first Binder driver, i.e., a local Binder driver.
3) Upon the receipt of the scheduling request, the first Binder driver determines whether a currently-requested service is the service of the first device itself or the service of the second device. In a case that the currently-requested service is the service of the first device itself, a process in FIG. 5 is executed. In a case that the currently-requested service is the service of the second device, the first Binder driver sends the scheduling request to the second Binder driver of the opposite device via USB communication, and the second Binder driver wakes up the service process of the opposite device.
4) The first Binder driver transmits a response message to the client process, so as to notify the client process that the scheduling request has been received.
5) After transmitting the scheduling request, the client process enters a waiting state, so as to wait for a response from the service process.
6) The second Binder driver determines a service process corresponding to the scheduling request, wakes up the service process, and forwards the scheduling request to the service process.
7) The service process parses content in the scheduling request, and sends a response (including the memory data of the called service) to the second Binder driver. The second Binder driver sends the response to the first Binder driver through USB communication and a shared memory mechanism.
8) Upon the receipt of the response, the first Binder driver wakes up the client process, the client process receives a processing result returned by the service process, and the entire calling process is ended.

In the embodiments of the present disclosure, the service is called between the devices based on a Binder mechanism, so the service is called in a cross-device manner more conveniently. In addition, the USB communication is triggered only in a case that the service needs to be called, so it is able to prevent the occurrence of any unnecessary communication.

The present disclosure further provides in some embodiments a device interaction method applied to a device interaction system. The device interaction system includes a first device and a second device, and the first device is communicatively coupled to the second device. As shown in FIG. 7, the device interaction method includes: Step 201 of receiving, by the first device, an instruction or an operation of a user, generating a calling request for a target service, detecting whether the target service is a service of the second device, and in a case that the target service is the service of the second device, sending the calling request to the second device; and Step 202 of receiving, by the second device, the calling request, and returning memory data of the target service to the first device.

In the embodiments of the present disclosure, upon the receipt of the instruction or operation of the user, the first device generates the calling request for the target service of the second device, sends the calling request to the second device, and receives the memory data of the target service returned by the second device. The first device shares the memory data of the target service, so the first device may directly call the target service. Through the technical solution in the embodiments of the present disclosure, it is able to call the service between the first device and the second device, thereby to facilitate the user to call the service of the second device through the first device.

In some embodiments of the present disclosure, the first device is installed with a first operating system, the second device is installed with a second operating system, and the first operating system is identical to, or different from, the second operating system. The first operating system is an Android system and the second operating system is a Windows system, or the first operating system is an Android system and the second operating system is an Android system. Obviously, the first device, the second device and the operating systems are not limited thereto.

The first device is communicatively coupled to the second device via a wireless local area network, or a data interface such as wireless hotspot, cable or USB interface, which will not be particularly defined herein.

The first device is an all-in-one machine, and the second device is an OPS device; or the second device is an all-in-one machine, and the first device is an OPS device. The words “first” and “second” are merely used to differentiate the devices from each other, and for each device, it is the first device, and an opposite device is the second device.

In some embodiments of the present disclosure, the device interaction method further includes: upon the receipt of the memory data of the target service returned by the second device, displaying, by the first device, the memory data of the target service on a display interface of the first device. In this way, a user may directly operate the target service using the display interface of the first device. To be specific, the target service is a camera service. The camera service is provided by the second device rather than the first device. Upon the receipt of the calling request for the camera service, the first device detects that the camera service is the service of the second device, sends the calling request to the second device, and receives memory data of the camera service returned by the second device. The first device displays the memory data of the camera service on the display interface, and the user directly uses the camera service using the display interface of the first device. In this way, the first device may utilize resources of the second device, so as to increase the utilization of the service resources, and facilitate the user to call the service of the second device through the first device.

In some embodiments of the present disclosure, the device interaction method further includes: sending, by the second device, the information about each service of the second device to the first device; and receiving, by the first device, the information about each service of the second device, and recording the information about each service of the second device in the service list of the first device.

In the embodiments of the present disclosure, the first device not only manages information about each service of the first device itself, but also manages the information about each service of the second device. The information about the service includes, but not limited to, a size and a name of the service, memory occupied by the service, and the device to which the service belongs. The information about each service of the first device and the information about each service of the second device are recorded in the service list of the first device. In this way, through the service list, the first device determines the target service is the service of the first device or the service of the second device. Identically, the second device not only manages information about each service of the second device itself, but also manages the information about each service of the first device. The second device is also provided with a service list for recording the information about each service of the first device and the information about each service of the second device.

In some embodiments of the present disclosure, the calling request for the target service includes a descriptor corresponding to the target service, and the descriptor corresponding to the target service is used to describe the information about the service, including a size and a name of the service, memory occupied by the service, etc. The detecting whether the target service is the service of the second device includes: detecting, by the first device, whether the target service is the service of the second device according to the descriptor corresponding to the target service and information about each service of the second device recorded in a service list of the first device.

The first device searches for a service record according to the descriptor corresponding to the target service, determines the information about the target service corresponding to the descriptor, and determines whether the target service is the service of the second device or the service of the first device according to the information about the target service. In a case that the target service is the service of the first device, the first device directly calls the target service; and in a case that the target service is the service of the second device, it sends the calling request to the second device.

The technical solution in the embodiments of the present disclosure is implemented through Android Binder architecture. In a case that the first device is the all-in-one machine and the second device is the OPS device, in the embodiments of the present disclosure, the Android Binder architecture is extended. As shown in FIG. 3, the service managers are arranged at a first device side and a second device side respectively, and each service manager records not only the information about the service of the corresponding device but also the information about the service of the opposite device. In a case that there are services with a same name, the services need to be numbered. For example, the first device and the second device are provided with a service FileManager, the service FileManager of the first device is numbered as FileManager1, and the service FileManager of the second device is numbered as FileManager2.

In other words, for the Binder driver, both the information about the service of the corresponding device and the information about the service of the opposite device are recorded in the object linked list Binder_ref (i.e., the above-mentioned service list). The first device is communicatively coupled to the second device via the USB, and the first device obtains the information about the service of the second device via the USB. To be specific, after the device is started, the service of the first device itself is registered into the service manager, the first device obtains the service of the second device via the USB, and the service of the second device is also registered into the service manager. In a case that the APP of the all-in-one machine requests for a corresponding service through the client process, a reference object Binder_ref (including the descriptor desc) is created in the kernel, and Binder_ref is notified to a Binder driver in the kernel of the OPS device. In this way, in a case that a certain service of the OPS device is called by the all-in-one machine through the client process, the Binder driver of the OPS device may correctly perform the processing.

In a case that a function of the target service is used by the client process through the proxy object, the descriptor desc corresponding to the target service is transferred to the Binder driver. The Binder driver searches for a corresponding Binder_node. In a case that the Binder driver fails to find the corresponding Binder_node at the first device, it may search for it at the second device. After the Binder driver has found a corresponding service user space object, a corresponding service may be used.

In some embodiments of the present disclosure, the first device includes a reserved first physical memory, and the first physical memory is divided into a plurality of physical pages; and the second device includes a reserved second physical memory, the second physical memory is divided into a plurality of physical pages, and page indices of the plurality of physical pages of the first device are different from page indices of the plurality of physical pages of the second device. Part of physical memory is reserved by the first device as the first physical memory shared with the second device, and part of physical memory is reserved by the second device as the second physical memory shared with the first device. Each physical page has a fixed size, e.g., 4K bits, the physical page is used to store the memory data of the service, and the memory data of the service occupies one or more physical pages. The physical memory of the device is managed using the physical pages, so as to prevent a waste of memory resources. In order to facilitate the calling of the memory data between the devices, the physical pages of the first device and the physical pages of the second device are assigned with different page indices, and in a case of searching for the physical page, each page index uniquely represents one physical page.

In some embodiments of the present disclosure, the page indices of the plurality of physical pages of the first device and the page indices of the plurality of physical pages of the second device are continuous. For example, the page indices of the physical pages of the first device include 0 to 1023, and the page indices of the physical pages of the second device include 1024 to 2047.

To be specific, in a case that the operating systems of the first device and the second device are started, part of the physical memory of the first device and the second device is reserved, i.e., the first physical memory is reserved by the first device, and the second physical memory is reserved by the second device. Then, the page indices are created for the two parts of physical memory to share the memory at a bottom layer in a cross-device manner. At an upper layer of the Android system, an accessed memory may be considered to be located inside the corresponding device. As shown in FIG. 4, the all-in-one machine includes a service A and a service B, memory data of the service A is stored through first three physical pages of the first device, and memory data of the service B is stored through fourth to seventh physical pages of the first device. The OPS device calls the memory data of the service B of the all-in-one machine through a virtual memory C, so as to call the service B. To be specific, in a case that the memory data of the service B of the all-in-one machine is called through the virtual memory C, the all-in-one machine sends the memory data of the service B to the OPS device via the USB. Upon the receipt of the memory data of the service B, the OPS device stores the memory data of the service B in the physical page or a cache, and it may use the memory data of the service B subsequently.

In some embodiments of the present disclosure, the returning the memory data of the target service to the first device includes: returning, by the second device, a first data packet to the first device, and the first data packet includes a protocol head, a length of the memory data, an address of a physical memory occupied by the memory data, and the memory data. In the embodiments of the present disclosure, the first data packet is designed, so as to transmit the memory data through the first data packet.

In some embodiments of the present disclosure, the first data packet further includes an index of the physical page storing the memory data. In this way, at the first device end, it is able to manage the physical mage storing the memory data.

In the embodiments of the present disclosure, the shared memory between the devices is executed via a USB communication protocol. Content delivered between the devices includes information indicating that a specific physical page is indexed, and data in the shared memory. The first data packet includes: HEAD, which indicates a protocol type of the first data packet; length, which indicates a size of the entire first data packet (in a case that the to-be-transmitted memory data is large, it is divided into a plurality of first data packets, i.e., a size of the memory data transmitted in one shot is controlled to be smaller than or equal to a size of the physical page, i.e., 4K bits); page index, which represents a serial number of a to-be-shared physical page, i.e., an index of the physical page; Phy addr, which represents an address of a to-be-shared physical memory; Len, which represents a specific length of the to-be-transmitted memory data; Opt, which represents an extensible item (an optional item); and Data, which represents the memory data.

Through the first data packet, it is able to transmit the memory data between the devices.

The indices of the physical pages are page indices uniformly created for the physical memory reserved by the first device and the second device in a case that the operating systems of the first device and the second device are started, and the addresses of the to-be-shared physical memory include an address of the first physical memory reserved by the first device and an address of the second physical memory reserved by the second device.

In the embodiments of the present disclosure, the service is called more conveniently between the devices based on a Binder mechanism. In some embodiments of the present disclosure, the first device includes a client process and a first Binder driver, and the second device includes a second Binder driver and a service process. The device interaction method specifically includes: receiving, by the first Binder driver, the calling request sent by the client process, determining information about the target service from the service list according to the descriptor in the calling request, determining whether the target service is a service of the first device or the service of the second device according to the information about the target service, and in a case that the target service is the service of the second device, sending the calling request to the second Binder driver; receiving, by the second Binder driver, the calling request, and sending the calling request to the service process corresponding to the target service; parsing, by the service process, the calling request, and sending the memory data of the target service to the second Binder driver; sending, by the second Binder driver, the memory data of the target service to the first Binder driver; and sending, by the first Binder driver, the memory data of the target service to the client process.

In the embodiments of the present disclosure, in order to call the service between the devices, FIG. 6 shows a Binder calling process for the Android system.
1) After the service process is started, it enters an interruptible waiting state, so as to wait for a request from the client process.
2) In a case that the client process needs to communicate with the service process, it sends the scheduling request to the first Binder driver, i.e., a local Binder driver.
3) Upon the receipt of the scheduling request, the first Binder driver determines whether a currently-requested service is the service of the first device itself or the service of the second device. In a case that the currently-requested service is the service of the first device itself, a process in FIG. 5 is executed. In a case that the currently-requested service is the service of the second device, the first Binder driver sends the scheduling request to the second Binder driver of the opposite device via USB communication, and the second Binder driver wakes up the service process of the opposite device.
4) The first Binder driver transmits a response message to the client process, so as to notify the client process that the scheduling request has been received.
5) After transmitting the scheduling request, the client process enters a waiting state, so as to wait for a response from the service process.
6) The second Binder driver determines a service process corresponding to the scheduling request, wakes up the service process, and forwards the scheduling request to the service process.
7) The service process parses content in the scheduling request, and sends a response (including the memory data of the called service) to the second Binder driver. The second Binder driver sends the response to the first Binder driver through USB communication and a shared memory mechanism.
8) Upon the receipt of the response, the first Binder driver wakes up the client process, the client process receives a processing result returned by the service process, and the entire calling process is ended.

In the embodiments of the present disclosure, the service is called between the devices based on a Binder mechanism, so the service is called in a cross-device manner more conveniently. In addition, the USB communication is triggered only in a case that the service needs to be called, so it is able to prevent the occurrence of any unnecessary communication.

The present disclosure further provides in some embodiments a device which, as shown in FIG. 8, includes a processor 32 and a memory 31. The memory 31 is configured to store therein a program or instruction executed by the processor 32, and the program or instruction is executed by the processor 32 to implement the steps of the above-mentioned device interaction method, which will not be particularly defined herein.

The present disclosure further provides in some embodiments a readable storage medium storing therein a program or instruction, and the program or instruction is used to be executed by a processor to implement the steps of the above-mentioned device interaction method.

The readable storage medium may include volatile or nonvolatile, removable or non-removable storage medium capable of storing therein information using any method or technique. The information may be a computer-readable instruction, a data structure, a program or any other data. The computer-readable storage medium may include, but not limited to, a Random Access Memory (e.g., Phase Change Random Access Memory (PRAM), Static Random Access Memory (SRAM) or Dynamic Random Access Memory (DRAM)), a Read Only Memory (ROM) (e.g., an Electrically Erasable Programmable Read Only Memory (EEPROM), a flash memory, a Compact Disc Read Only Memory (CD-ROM) or a Digital Video Disk (DVD)), a magnetic storage device (e.g., a cassette magnetic tape or a magnetic disk), or any other non-transitory medium capable of storing therein information which can be accessed by a computing device. As defined in the present disclosure, the readable storage medium may not include any transitory media, e.g., modulated data signal or carrier.

It should be appreciated that, such words as “include” or “including” or any other variations involved in the present disclosure intend to provide non-exclusive coverage, so that a process, method, article or device including a series of elements may also include any other elements not listed herein, or may include any inherent elements of the procedure, method, article or device. If without any further limitations, for the elements defined by such sentence as “including one . . . ” , it is not excluded that the procedure, method, article or device including the elements may also include any other identical elements. It should be further appreciated that, apart from the described or discussed order, the steps may also be performed simultaneously or in a reverse order, so as to achieve the mentioned functions. For example, new steps may be added, or some steps may be omitted or combined. In addition, the features described with reference to some embodiments may be combined in the other embodiments.

Through the above-mentioned description, it may be apparent for a person skilled in the art that the present disclosure may be implemented by software as well as a necessary common hardware platform, or by hardware, and the former may be better in most cases. Based on this, the technical solutions of the present disclosure, partial or full, or parts of the technical solutions of the present disclosure contributing to the related art, may appear in the form of software products, which may be stored in a storage medium (e.g., ROM/RAM, magnetic disk or optical disk) and include several instructions so as to enable a terminal device (mobile phone, computer, server, air conditioner or network device) to execute the method in the embodiments of the present disclosure.

The description has been given hereinabove in conjunction with the drawings and the embodiments, but the present disclosure shall not be limited to the above preferred embodiments. These embodiments are for illustrative purposes only, but shall not be used to limit the scope of the present disclosure. A person skilled in the art may make various alternations or modifications without departing from the spirit of the present disclosure and the scope defined in the appended claims, which also fall within the scope of the present disclosure.

1. A device interaction system, comprising a first device and a second device, wherein the first device is communicatively coupled to the second device;
the first device is configured to receive an instruction or an operation of a user, generate a calling request for a target service, detect whether the target service is a service of the second device, and in a case that the target service is the service of the second device, send the calling request to the second device; and
the second device is configured to receive the calling request, and return memory data of the target service to the first device.

2. The device interaction system according to claim 1, wherein the first device is further configured to, upon the receipt of the memory data of the target service returned by the second device, display the memory data of the target service on a display interface of the first device.

3. The device interaction system according to claim 1, wherein the calling request for the target service comprises a descriptor corresponding to the target service; and
the first device is specifically configured to detect whether the target service is the service of the second device according to the descriptor corresponding to the target service and information about each service of the second device recorded in a service list of the first device.

4. The device interaction system according to claim 3, wherein the second device is further configured to send information about each service of the second device to the first device; and
the first device is further configured to receive the information about each service of the second device, and record the information about each service of the second device in the service list of the first device.

5. The device interaction system according to claim 3, wherein the first device is configured with a service manager, and the service manager is configured to receive the information about each service of the second device and record the information about each service of the second device in the service list of the first device.

6. The device interaction system according to claim 1, wherein the first device comprises a reserved first physical memory, and the first physical memory is divided into a plurality of physical pages; and the second device comprises a reserved second physical memory, the second physical memory is divided into a plurality of physical pages, and page indices of the plurality of physical pages of the first device are different from page indices of the plurality of physical pages of the second device.

7. The device interaction system according to claim 6, wherein the page indices of the plurality of physical pages of the first device and the page indices of the plurality of physical pages of the second device are continuous.

8. The device interaction system according to claim 6, wherein the first device is specifically configured to receive a first data packet returned by the second device, and the first data packet comprises a protocol head, a length of the memory data, an address of a physical memory occupied by the memory data, and the memory data,
wherein the first data packet further comprises an index of the physical page storing the memory data.

9. (canceled)

10. The device interaction system according to claim 1, wherein the first device comprises a client process, and the client process is an application process.

11. The device interaction system according to claim 4, wherein the first device comprises a client process and a first Binder driver, and the second device comprises a second Binder driver and a service process;
the first Binder driver is configured to receive the calling request sent by the client process, determine information about the target service from the service list according to the descriptor in the calling request, determine whether the target service is a service of the first device or the service of the second device according to the information about the target service, and in a case that the target service is the service of the second device, send the calling request to the second Binder driver;
the second Binder driver is configured to receive the calling request, and send the calling request to the service process corresponding to the target service;
the service process is configured to parse the calling request, and send the memory data of the target service to the second Binder driver;
the second Binder driver is further configured to send the memory data of the target service to the first Binder driver; and
the first Binder driver is further configured to send the memory data of the target service to the client process.

12. The device interaction system according to claim 1, wherein the first device is an all-in-one machine, and the second device is an Open Pluggable Specification (OPS) device; or
the second device is an all-in-one machine, and the first device is an OPS device, and/or
the first device is coupled to the second device via a Universal Serial Bus (USB).

13. (canceled)

14. A device interaction method, applied to a device interaction system, wherein the device interaction system comprises a first device and a second device, and the first device is communicatively coupled to the second device, wherein the device interaction method comprises:
receiving, by the first device, an instruction or an operation of a user, generating a calling request for a target service, detecting whether the target service is a service of the second device, and in a case that the target service is the service of the second device, sending the calling request to the second device; and
receiving, by the second device, the calling request, and returning memory data of the target service to the first device.

15. The device interaction method according to claim 14, further comprising:
upon the receipt of the memory data of the target service returned by the second device, displaying, by the first device, the memory data of the target service on a display interface of the first device.

16. The device interaction system according to claim 14, wherein the calling request for the target service comprises a descriptor corresponding to the target service; and the detecting whether the target service is the service of the second device comprises:
detecting, by the first device, whether the target service is the service of the second device according to the descriptor corresponding to the target service and information about each service of the second device recorded in a service list of the first device.

17. The device interaction method according to claim 16, further comprising:
sending, by the second device, the information about each service of the second device to the first device; and
receiving, by the first device, the information about each service of the second device, and recording the information about each service of the second device in the service list of the first device.

18. The device interaction method according to claim 14, wherein the first device comprises a reserved first physical memory, and the first physical memory is divided into a plurality of physical pages; and the second device comprises a reserved second physical memory, the second physical memory is divided into a plurality of physical pages, and page indices of the plurality of physical pages of the first device are different from page indices of the plurality of physical pages of the second device.

19. The device interaction method according to claim 18, wherein the page indices of the plurality of physical pages of the first device and the page indices of the plurality of physical pages of the second device are continuous.

20. The device interaction method according to claim 18, wherein the returning the memory data of the target service to the first device comprises:
returning, by the second device, a first data packet to the first device, and the first data packet comprises a protocol head, a length of the memory data, an address of a physical memory occupied by the memory data, and the memory data,
wherein the first data packet further comprises an index of the physical page storing the memory data.

21. (canceled)

22. The device interaction method according to claim 16, wherein the first device comprises a client process and a first Binder driver, and the second device comprises a second Binder driver and a service process; wherein the device interaction method specifically comprises:
receiving, by the first Binder driver, the calling request sent by the client process, determining information about the target service from the service list according to the descriptor in the calling request, determining whether the target service is a service of the first device or the service of the second device according to the information about the target service, and in a case that the target service is the service of the second device, sending the calling request to the second Binder driver;
receiving, by the second Binder driver, the calling request, and sending the calling request to the service process corresponding to the target service;
parsing, by the service process, the calling request, and sending the memory data of the target service to the second Binder driver;
sending, by the second Binder driver, the memory data of the target service to the first Binder driver; and
sending, by the first Binder driver, the memory data of the target service to the client process.

23. A device, comprising a processor and a memory, wherein the memory is configured to store therein a program or instruction executed by the processor, and the program or instruction is used to be executed by the processor to implement the steps of the device interaction method according to claim 14.

24. (canceled)
